(19) United States
(12) Patent Application Publication
(10) Pub. No.: US 2020/0222793 A1
(43) Pub. Date: Jul. 16, 2020

(54) MODULAR EXPANSION SYSTEM FOR BOARD GAMES WITH ELECTRONIC CONTROL

(71) Applicant: XPLORED S.R.L., Genova (IT)

(72) Inventor: Enrico GAROFALO, Rapallo (IT)

(21) Appl. No.: 16/639,603

(22) PCT Filed: Aug. 20, 2018
(86) PCT No.: PCT/IT2018/050158

§ 371 Date: Feb. 17, 2020

(30) Foreign Application Priority Data
Aug. 18, 2017 (IT) 102017000094362

(51) Int. Cl. A63F 3/00; A63F 13/214

(52) U.S. Cl. CPC A63F 3/0052; A63F 3/00643; A63F 13/214; A63F 2009/2457; A63F 2003/00665; A63F 2003/00668; A63F 2003/00675; A63F 2003/00381

(57) ABSTRACT

The present invention aims at making a modular expansion system for hybrid or table games with electronic control, allowing to extend the traceability and extend the interaction area outside an original sensorized surface and especially outside the investigation area of a contactless identification system associated with the main board of the gaming system. This allows the user to enlarge the gaming surface outside the interactive surface of the original system and to obtain an interactive gaming surface which reproduces, for example the environment layout, enabling to interact in a more realistic way with the virtual gaming events and environments. According to the proposed solution, any gaming board, equipped with an original magnetic tracking system for tracking position and a identifying system (for example contactless or RFID type) for the identification of the playable elements and accompanied by physical interaction elements and a system communicating with a gaming apparatus (PC, tablet, console) where a software or an interacting video game is running, is expanded/extended by means of a series of additional elements, able to connect to each other and to said gaming board, said elements being provided with an extremely economical and reliable position tracing system based only on magnetic sensors and an appropriate tracing method.

### STATE OF THE ART

Within the gaming boards, and in particular within control systems of the so-called “hybrid games” (video games combined with physical toys), the interaction between physical and virtual environments is based on the positioning and/or movement of objects or gaming elements on a predefined sensorized surface, said surface being limited and generally squared-shaped (as, for example, in U.S. Pat. No. 5,853,327, US20070015588, WO2011107888, WO2012033863, US2006246403).

Such devices are particularly suitable for being used for controlling video games and educational games, by means of a connection with personal computers or game consoles but they are limited by the predefined shape of the interactive surface and its size so they cannot be used to make board games interactive.

This type of games, in fact, mostly involves the use of a large board, often foldable or consisting of different modules, which can be positioned so as to symbolically recreate settings and paths even very extensive and complex (as, for example, in US20150028544), within which players must move their characters, facing different obstacles and interacting through gaming elements (as in U.S. Pat. No. 5,584,484).

Recently, new board games are getting popular where a part of the interaction (for example the random events generation or the tracking of game shifts and player choices) takes place by means of external tools, such as tablets or personal computers, allowing to increase the challenge level and to increase the game possibilities.

In order to provide this level of interaction, however, many games require the user to manually enter information about the actions taken, the choices made and, in many cases, even the result of the dice roll in the support software. The technological solutions currently on the market, such as the aforementioned interactive boards, in fact, do not allow interaction between the physical gaming environment (board) and the virtual environment (app or video game) if the playable elements are outside a predefined sensored surface of the board and, above all, do not allow to modify and/or expand the relative playable area according to shapes and sizes which can be freely configured depending on the user's choice and gaming situations. At the most, some solutions allow to replace the graphic panel on the sensorized area (as, for example, in US2016287979 or WO2011107888), or enable to modify the gaming area itself (as in WO2012033863, FIG. 11, 12, 16) by means of additional elements that must however be positioned on the main board, and in particular in the range of contactless identification system used, but cannot “increase” the interactive surface extending it outside of this: even in these solutions, moving the objects outside the predefined sensorized surface, the position and identification information are lost and this does not enable to manage extended movements of the individual miniatures and or to allow an interaction/movement of the miniatures consistent with the conformation of the game environment and corresponding to the virtual/digital part of the game.

In order to solve these problems, some solutions have been developed which, however, are characterized by a significant complexity and very high production costs, as well as significant functional limits. For example, solutions that use flexible boards are known, in which a network of RFID antennas is integrated, one for each box/space where the interactive elements can be positioned, which can be managed by a central unit equipped with appropriate electronic interaction devices (as in US20100032900). Further solutions allow to increase the gaming area by cloning and flanking, by means of connectors, further boards, provided with the same tracing and identification means of the main one. In many of these solutions (as, for example, in US2006246403, in FIG. 6 of said patent) the extent of the gaming area which can be traced is made by means of the combination of different identical boards, in which there are identification and tracing systems based on the use of multiple RFID readers and antennas, able to identify and trace objects and miniatures.

All these solutions are extremely complex and expensive due to the difficult management of the RFID antennas network they are based on. Such RFID antennas require the use of extremely complex printed circuits, the use of multiplexer circuits or multiple readers and, in addition, they are extremely subject to interference.

Further solutions involve the use of sensored modular elements, each of them provided with power supply and independent communication systems (as in US20080280682), however, such devices have a considerable functional complexity (they involve the use of accelerometers, tactile sensors and radio chips, for each modular element) and consequently have very high production costs.

### TECHNICAL FIELD

The object of the present invention is to make a modular expansion system for hybrid board games, with electronic control, which allows to extend the traceability area and the interaction outside the original sensorized surface of the game, especially outside the sensing area of an identification system associated with the gaming system.

This allows the user to obtain a new and better level of interaction between the physical and the virtual environment, based on a modular, interactive gaming surface which can be freely configured, which does not limit the interaction to a pre-established size and shape, but which allows to make, physically, an interactive and modular gaming surface which reproduces, for example, the environments layout, enabling to interact in a more realistic way with the virtual events and with different gaming environments.

### DISCLOSURE OF THE INVENTION

According to the proposed solution, any gaming board, provided with an original tracing system, possibly contactless, and an identification system (for example via RFID) of playable elements and accompanied by physical interaction elements and a system communicating with a gaming apparatus (PC, tablet, console) in which a program or video game to interact with is running can be expanded/extended by means of a series of additional elements, able to interconnect with each other and with said gaming board, provided with an extremely economical and reliable position tracing system based only on magnetic sensors and accompanied with an appropriate tracing method.

In the exemplary embodiment described below, the proposed gaming board includes magnetic sensors, a contactless identification system for interactive elements (for example optical or RFID) and a data processing unit, able to manage a communication bus and different connection ports, in the form of mechanical interlocks and which can be expanded by the user by means of additional elements. Additional modular elements can be connected to each of the aforementioned interlocks in order to extend and increase the interactive gaming area; such modular elements consisting of sensorized surfaces, provided exclusively with a series of magnetic sensors and able to detect the position and movement of objects provided with appropriate magnetic markers. Each expansion element has a processing unit for acquiring the status information of the magnetic sensors and transmitting such information to the central unit through an appropriate fieldbus. The expansion elements, of different shape and size, are also provided with further interlocks, to which further additional elements can be freely connected, enabling to create interactive surfaces even very complex and ramified allowing to build a multitude of shapes of different sizes.

On the central unit, figures, objects or gaming interaction elements can be freely positioned; they are provided with magnetic markers and/or identifying markers which can be read by the identification system, in order to allow the player to interact, via physical actions, with the program or digital game. For example, cards provided with identifying markers can be positioned on the surface in order to transmit to the gaming system the will to perform certain actions, or elements with magnetic markers can be arranged, identifying the position (relative to the interactive surface) wherein an action is to be performed. Miniatures provided with magnetic markers and identifying markers can also be positioned, enabling the user to select, in this way, the character to be used in the game and to define its position and movement on the gaming surface itself.

By moving the miniature outside the surface of the central unit, on one of the additional expansion elements, connected to the central unit itself via interlocks, the magnetic sensors system in said expansion unit enables to trace the movements of the character, thus allowing the user to follow complex physical paths, correlated and consistent with the contents displayed within the video game.

By positioning and moving on said further additional elements provided with magnetic marker, the user is able to simulate the movement of several objects and/or characters, within the gaming environments, being able to rely on a physical representation on scale of the environment itself (layout), which is enables to improve and increase the level of interaction.

The system proposed includes the following elements:

a) A main gaming board, characterized by the following elements:
Central processing unit (master).
Information storing memory.
Interface for communication with the gaming system (Wireless or wired).
Magnetic sensors for detecting objects provided with magnetic markers.
Contactless identification system (e.g. RFID or optical).
A series of physical connections to hook expansion elements.
A fieldbus (wired or wireless) used to communicate the base with further expansion elements.
   b) A series of expansion elements of the main board characterized by:
A surface with varying shape and size from element to element, provided with magnetic sensors which cover the entire area.
A series of physical connections/interlocking joints allowing to connect with the main board or to connect with further expansion elements (cascaded and/or branched).
A processing unit (slave) able to acquire magnetic sensor data and to transmit them (via wired or wireless fieldbus) to the central processing unit (master) placed on the main gaming board.
   c) A series of gaming elements and accessories:
Miniatures depicting the characters, provided with an identifying marker (e.g.: QR code or RFID tag) and a magnetic marker (to be detected by the sensors on the base and on the expansions).
Miniatures and interactive elements provided with only magnetic markers, representing obstacles or other gaming elements.
Cards and other gaming elements provided only with identifying maker (e.g.: QR code or RFID tag), used to control actions, activate objects, trigger events in the digital game (positioned on the base, are identified and, in correspondence, an effect is activated in the game: for example, use a certain object to hit an enemy, or activate a power to see through the walls, etc.).

From the implementation point of view:
The expansion elements, not requiring any RFID antenna or other on-board identification systems, can also be made with very economical technologies through a semi-rigid support (for example plastic or cardboard) with a flexible type PCB inside.
The magnetic sensors and the inner circuits of the expansion elements can be made with traditional discrete elements (hall sensor, reed sensor, etc.), but in a preferred embodiment they can be realized with printing and superficial deposition techniques of substances sensitive to magnetic fields (for example graphene, magneto-resistive inks, etc.).
In case of a “wired” bus, the expansion elements can be supplied directly from the main base, via the same connectors used for the fieldbus.
The system could include game dice able to communicate with the central unit and/or directly with the gaming system, which allow to manage voluntary random result interaction elements (for example, outcome of a hit in combat, movement in an exploration game shift, etc.).

### DETAILED DESCRIPTION OF THE DRAWINGS

Further characteristics and advantages of the proposed technical solution will be further explained in the following description of a preferred but not exclusive embodiment integrated with the following accompanying figures where:

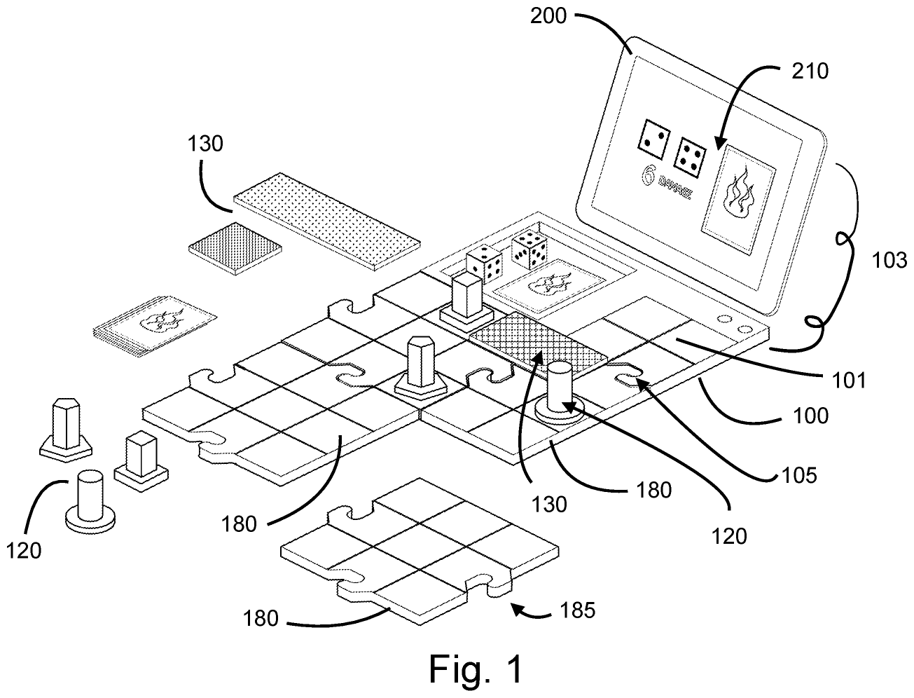

FIG. 1 represents an example of the modular expansion system for board games with electronic control.

FIG. 2 represents an example of a main board which can be extended by means of the proposed solution.

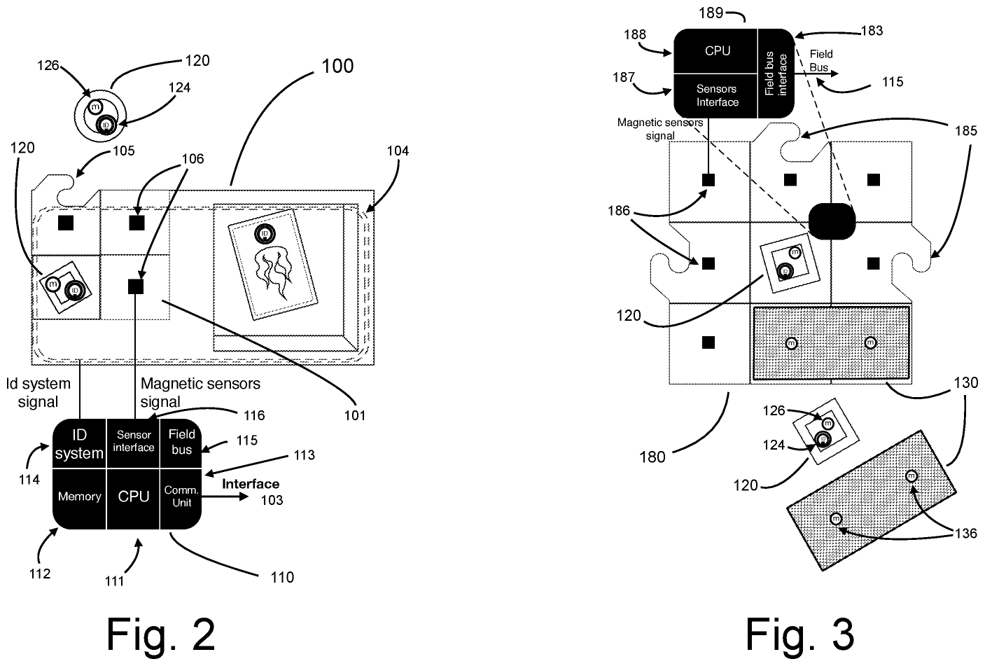

FIG. 3 represents an example of an expansion unit to be employed within the proposed system.

### BEST MODE FOR CARRYING OUT THE INVENTION

With reference to the attached drawings, and in particular to FIG. 1 of the same, an example is provided in order to explain how to implement the modular expansion system for board games with electronic control object of the invention; such system consisting of:
a main board (100), provided with a sensorized area (101), intended for positioning appropriate miniatures (120). Said board (100) being able to communicate, via an appropriate interface (103), wired or wireless, with a gaming platform (200) on which a specific gaming software (210) is running. Said board (100) is furthermore provided with at least one interlock (105) suitable for enabling the “cascade” connection of appropriate expansion elements (180);
A series of expansion elements (180), each provided with appropriate interlocks (185) for interconnection with the main board and with further expansion elements, able to communicate with the main board via fieldbus (115);
A series of miniatures depicting game characters (120) which can be freely positioned on the sensorized area (101) of the main board (100) and on the expansion elements (180);
A series of decorative elements (130), which can be positioned on the expansion elements (180).

With reference to the attached drawings, and in particular to FIG. 2 thereof, an example of a main board (100) is provided and it is represented how the proposed expansion system object can extend the functions of such main board. The board consists of a sensorized area (101), it is provided with a series of magnetic sensors (106) and also with an identification system (104) such as the antenna of a RFID system or the vision field of an optical recognition system.

Objects (120) provided with magnetic markers (126) and with identification markers (124), as for example RFID tags or QR code can be positioned, within the sensorized area (101).

Furthermore, the base (100) is provided with at least one interlocking connection system (105), suitable for enabling connection with further sensorized expansion elements.

Furthermore, the base is equipped with a central data processing unit (110), consisting of a CPU (111) able to acquire the data produced by the identification system (114) connected to the identification tool (104), by the management interface (116) for the magnetic sensors (106) installed on the board, as well as those exchanged with the expansion elements through a wired or wireless fieldbus (115). Data of the various systems can be memorized on a memory (112), processed by the CPU (111) and, then, transmitted to an outer device (200) via an interface (103), by means of an appropriate communication unit (113).

With reference to the attached drawings, and in particular to FIG. 3 thereof an exemplary embodiment of an expansion unit (180) according to the invention is represented. Said expansion unit has a series of interlocks (185), for connecting to the main board and/or to other expansion units, and is provided with a series of magnetic sensors (186), controlled by a microcontroller (189), through an integrated interface (187) which includes also a processing unit (188) and an interface (183) for a fieldbus (115) either wired or wireless, which enables communication with the main board.

Gaming elements (130) provided with appropriate magnetic markers (136) and gaming elements (120) provided with magnetic marker (126) and identifying marker (124) can be freely positioned on the expansion elements.

With reference to the attached drawings and in particular to FIGS. 1, 2 and 3, it is represented the control system object of the invention (100) including all the related expansion units (180) and all the elements (120, 130) that can be employed by the user to interact with a software (210) running on the gaming platform (200) connected to the system with the interface (103).

While using the main board (100), the player can position objects (120) on the sensorized area (101); such objects are provided with an appropriate identification marker (124) and magnetic marker (126). The system identifies the objects through the identification apparatus (114) and acquires the information related to the initial position of the objects through the magnetic sensor system (116); such information is stored in the memory (112) and used by the CPU (111) for tracking of the objects, as long as they move.

By connecting an expansion element (180) to the main board (100) through the interlock (105), said expansion element transmits to the master CPU (111) by means of the fieldbus (115) the information concerning to the state of its own magnetic sensors (186). When an object (120) leaves the sensorized area (101) of the main board (100) and moves to an expansion element (180), the central system (110) keeps trace of the object's movements itself through the information provided from the magnetic sensor network (186) and transmit such information to the gaming system (200), using an appropriate method consisting of the following steps:
detecting the identifying markers (124) of the playable elements (120) by means of the identification system (114) of the main board (100);
acquiring the state of the magnetic sensors (186) for all the expansion elements (180) connected to the fieldbus (115);
for each playable element (120) leaving the sensorized area of the main board (100), the system for the possible activation of a magnetic sensor (186) located on one of the expansion elements (180) and eventually memorize the identification and position data pair;
tracking the subsequent displacements of each playable element (120) outside the sensorized area of the board (100) by memorizing the sensor sequence (186) activated by the magnetic marker (126) moving along the expansion elements (180).

By placing gaming elements provided with magnetic markers (130) on the expansion elements (180), the user can prevent the movement of the interactive objects (120), determining obligatory paths and particular conformations of the resulting interactive gaming area.

By joining the main board (100) together with multiple expansion elements (180), through the interlocks (105, 185), the user can make interactive surfaces also very extensive and articulated, whose shape and dimensions can be detected and mapped by the gaming system through a method which allows to identify all the expansion elements (180) used and connected to the main board (100) through the fieldbus (115).

Such method comprises the following steps:
acquiring, via fieldbus (115) the univocal identification codes of the CPUs (188) for all the expansion elements (180) used and connected to the fieldbus itself;
acquiring, for each of the expansion elements (180) identified in the previous point, the univocal identification codes of the CPUs (188) of the adjacent expansion elements (180), connected through the interlocks (185);
correlating the acquired data to the previous points and memorizing the data related to the spatial positioning and mapping of the identified expansion elements (180).

### INDUSTRIAL APPLICABILITY

The proposed solution applies to hybrid table games, with electronic control, which can be connected to electronic systems such as PC, Console, Tablet, Smartphone, for recreational play activities. The proposed solution is effective, easy to make and employs and enables to extend the interactive board games area with electronic control over the original surface, through a series of low cost expansion modular elements which can be freely positioned, thus allowing the user to make interactive surfaces also very complex and extensive and able to reproduce gaming environments with varying shapes and sizes; thanks to modularity, enables to create extremely various interface systems in terms of size and shape, not limited only to the original shape of the main board, but which can be freely configured based on the user's will or based on specific gaming patterns. This expansion system, for example, can be used to reproduce gaming environments with very variable shapes and sizes, extending and enlarging the gaming surface in addition to the main board interactive area geometry, allowing to create a physical depiction of the gaming environments layout, reproduced in the software (210) running on the gaming system (200).

1. A modular expansion system for board games comprising:
a main board equipped with an identification system configured to detect playable elements provided with an identifying marker;
a magnetic tracking system configured to detect playable elements provided with a magnetic marker;
a processing unit having a communication interface and at least one main board interlock;
a plurality of gaming area expansion elements for the main board, the gaming area expansion elements being equipped with magnetic sensors and a processing unit provided with a univocal identification code; and
fieldbus for connecting the gaming area expansion elements to the main board.

2. The modular expansion system for board games according to claim 1, where the gaming area expansion elements further comprise:
at least one interlock configured to be coupled with the at least one main board interlock or with other expansion element interlocks; and
variable shape and size pieces depending on an implemented videogame environment.

3. The modular expansion system for board games according to claim 1, where the processing unit further comprises:
an interface connected to the magnetic sensors; and
an interface connected to the fieldbus.

4. The modular expansion system for board games according to claim 1, wherein the gaming area expansion elements comprise a printed circuit made on a flexible support.

5. The modular expansion system for board games according to claim 1, wherein the magnetic sensors are formed by a printed electronic technique and a surface deposition of substances sensitive to a magnetic field.

6. The modular expansion system for board games according to claim 2, wherein the gaming area expansion elements are powered through the at least one interlock.

7. The modular expansion system for board games according to claim 2, wherein the gaming area expansion elements communicate via the fieldbus through the at least one interlock.

8. A method for tracking positioning and movement of playable elements provided with magnetic marker and identifying marker within a modular expansion system for board games, comprising:
providing the modular expansion system, the modular expansion system comprising:
a main board equipped with an identification system configured to detect playable elements provided with an identifying marker;
a magnetic tracking system configured to detect playable elements provided with a magnetic marker;
a processing unit having a communication interface and at least one main board interlock;
a plurality of gaming area expansion elements for the main board, the gaming area expansion elements being equipped with magnetic sensors and a processing unit provided with a univocal identification code; and
a fieldbus for connecting the gaming area expansion elements to the main board;
detecting identifying markers of the playable elements by the identification system provided with the main board;
collecting data about a state of the magnetic sensors for all the expansion elements connected to the fieldbus;
for every playable element, leaving the main board sensorized area, verifying the activation state of the magnetic sensors installed on all the expansion elements, and memorizing identification and positioning corresponding to the element actually occupied by the playable element; and
tracking any subsequent displacements of each playable element outside the sensorized area of the board by memorizing the sensors sequence activated by the magnetic marker during its movement along the expansion elements.

9. The method according to claim 8, further comprising:
gathering, by a fieldbus connection, the univocal identification codes of the CPUs related to the currently connected expansion elements;
collecting, for each expansion elements as identified, the univocal identification codes of the CPUs of the adjacent expansion elements; and
correlating data collected at the previous points and memorizing the data related to spatial positioning of the identified expansion elements.

10. A modular expansion system for board games, comprising:
a main board comprising an identification system, the identification system being configured to detect an identifying marker of at least one playable element;
a magnetic tracking system configured to detect a magnetic marker of the at least one playable element;
a processing unit comprising a communication interface and at least one main board interlock;
a plurality of gaming area expansion elements for the main board, the gaming area expansion elements being equipped with magnetic sensors and a processing unit provided with a univocal identification code; and
a fieldbus for connecting the gaming area expansion elements to the main board.
